(19) United States
(12) Patent Application Publication
(10) Pub. No.: US 2026/0080802 A1
(43) Pub. Date: Mar. 19, 2026

(54) Smart visual sign language translator, interpreter and generator

(71) Applicant: DATACRUX INSIGHTS PRIVATE LIMITED, Pune (IN)

(72) Inventor: MANISHA VINAYAK JADHAV, Pune (IN)

(21) Appl. No.: 19/108,453

(22) PCT Filed: Sep. 16, 2023
(86) PCT No.: PCT/IN2023/050866

§ 371 Date: Mar. 4, 2025

(30) Foreign Application Priority Data
Sep. 17, 2022 (IN) 202221053220

(51) Int. Cl. G09B 21/00; G06V 10/82; G06V 40/10; G06V 40/20; G10L 13/00; H04N 7/15

(52) U.S. Cl. CPC G09B 21/009; G06V 10/82; G06V 40/10; G06V 40/28; G10L 13/00; H04N 7/15

(57) ABSTRACT

The present invention relates to Smart visual sign language translator, interpreter, and generator. The invention is a process of two-way real time communication between person with hearing and/or speech disabilities (PwD) and normal person, wherein sign language of PwD (100) is captured as video, converted into image frames, interpreted using DCN trained model (104) and context based Natural language generation (105); and then converted into text (106) and speech (107) for a normal person to understand; similarly, communication of normal person is captured using mic (108), and is converted to text using speech to text converter (109) wherein speech recognition is done using Deep Stack Network. Module of Text and context analysis using Natural Language Understanding (110) analyses text received from (109). Interpreted text from (110) is used for predicting text to nearest sign image. These sign images are used for creating meaningful sequence of sign language gestures in (112).

### TECHNICAL FIELD

The present invention generally relates to Smart visual sign language translator, interpreter and generator. An artificial intelligence-based real time video communication between Person with Disability (speech and hearing disabled) henceforth referred as PwD and normal person using Deep convex network model (DCN) also called as Deep Stack network, context based natural language processing (NLP) techniques and Augmented Reality (AR) is disclosed. In particular, the present invention discloses automated process of visual sign language translator, interpreter and generator using artificial Intelligence and system thereof.

### BACKGROUND ART

India has almost 3 crores people with disability (PwD) of which around 1.3 crores is employable but only 34 lakhs of them have been employed.

Hearing and speech disabled people are not part of the mainstream in corporate or other professional sectors. Our invention uses an Artificial intelligence-based model for real time communication between PwD with normal people. Our invention provides solution for interpretation and translation of sign language to text or speech and vice a versa with real time sign language video generation using Deep convex network model (DSN/DCN), context based natural language processing (NLP) techniques and augmented reality. DSN deep learning architecture is different from the other deep neural networks. DSNs are also frequently called DCN-Deep Convex Network. DSN/DCN comprises a deep network, but it's actually a set of individual deep networks. Each network within DSN has its own hidden layers that process data. This architecture has been designed in order to improve the training issue, which is quite complicated when it comes to traditional deep learning models. Due to many layers, DSNs consider training, not a single problem that has to be solved but a set of individual problems.

Typically, DSNs consist of three or more modules. Each module consists of an input layer, a hidden layer, and an output layer. These modules are stacked one on top of another, which means that the input of a given module is based on the output of prior modules/layers. This construction enables DSNs to learn more complex classification than would be possible with just one module. The Deep Stacking Network (DSN) model uses easy-to-learn blocks to create a complex parallel parameter training network.

The core theory of DSN architecture is the stacking principle, in which basic function modules or classifiers are first assembled and then stacked up to each other in order to learn complex functions or classifiers. Our invention makes use of these DSN for sign language generation in accurate and efficient manner which is nowhere suggested.

The motivation behind this invention is that, once PwD become part of the mainstream, they can have higher education, good jobs and live a better life. This invention can work as a standalone tool as well as plug in for existing video conferencing tools.

PwD communicates messages through sign language and captured using video camera. The meaning of signs is understood automatically using trained model of DCN and converts sign language to text, so that any normal person can read the interpretation; wherein when normal person communicates a message, it is converted to text using speech to text converter, this text is interpreted using context based NLP techniques and corresponding stored augmented sign language videos are searched and appropriate video is played in real time to let the specially disabled person understand the conversation.

Sign language to text using Deep Convex network model, breaking video in images, interpreting them in text (video to text), display text and read aloud simultaneously; in addition, when normal person communicates with PwD, its speech is converted to sign language video as well as text using Deep convex models of seq2seq and semantic RNN models with NLP to understand the context is the inventive process.

### SUMMARY OF INVENTION

The present invention generally relates to Smart visual sign language translator, interpreter and generator. An artificial intelligence-based real time video communication between Person with Disability (speech and hearing disabled) and normal person using Deep convex network model (DCN), context based natural language processing (NLP) techniques and Augmented Reality (AR). In particular, the present invention discloses automated process of visual sign language translator, interpreter and generator for PwD using artificial Intelligence and system thereof.

This invention is for empowering Person with Disability (Speech and/or Hearing disabled) to communicate, learn and work with normal people. It aims to bring PwD people in stream of normal people and work with hand in hand in any field. Our invention makes use of Deep Convex network and NLP techniques for converting sign language into text or speech and understand the context. Similarly, converts normal language into sign language videos and text to convey messages to PwD.

Person with disabilities PwD (Speech and/or Hearing) (100) communicates messages through sign language using a device with video calling capability denoted by (101). Our invention is focused on understanding the meaning of signs using AI/ML models to convert sign language to text, so that anyone can read the interpretation. Video Conferencing system (102) decodes meaning of sign language using Real-time video analytics. (102) has module (103) to segment video received from (101) into image frames. In module Image (Sign) to Text interpretation using DCN trained model (104), images/sequence of images (shots) is mapped with closest matching meaning of sign images or sequence of sign images for image to text interpretation. Separate Deep learning network (DCN) is used for (104). Text interpretation received from (104) is further processed for generating meaningful context-based text in module of Natural language Generation (NLG) for meaningful context-based interpretation (105) using Turing, MT-NLG and Transformer-based like generative language model. Output received from (104) is input for (105). Text generated in (105) is displayed on screen of output device (106). Text from (106) is read out loud using text to speech coveter module (107). Any normal person (108) can see text on (106), and listen to speech in (107). A person (108) is now in a position to understand what PwD (100) wants to communicate.

The invention supports two-way communication between PwD (100) and normal person (108). When Normal Person (108) responds to (100), we have designed different block for making this communication happen. Video Conferencing system module (116) at normal person (108) side focuses on decoding meaning of sign language using Real-time video analytics. Communication from (108) is converted to text using speech to text converter (109) where speech recognition is done using DNN. Module of Text and context analysis using Natural Language Understanding (110) analyses text received from (109) using DNN (like BERT/LNet). Text and context understood from (110) is used for predicting text to nearest sign image. These sign images are used for creating meaningful sequence of sign language gestures in (112). (112) refers to (114) which is sign language video database with respective meaning with key terms, tokens. (114)) and (112) collectively provides input for Animation of sign gestures (113) which are predictions generated from server hosted DCN model and Text of the same. Animation of sign gestures is displayed on (101) which can be easily understood by (100).

An object of the present invention is to
a. Build real time communication channel between speech and hearing disabled persons PwD and normal persons.
b. Convert sign language into text and speech using context analysis and Natural language generation techniques in real time.
c. Convert natural language into sign language video and text using DCN model and augmented reality.
d. Establish two-way real-time audio/video communication between PwD and Normal person with accuracy and efficiency.
e. Empower PwD to be part of normal person community to learn, work and contribute their knowledge and expertise for betterment of society/industry.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention is described and explained with additional specificity and detail with the accompanying drawings.

### TECHNICAL PROBLEM

In current methods we don't have any real time communication channel for 2-way communication between person with hearing and speech disability and normal person. normal person should be familiar with sign language(facial/hand) to interact with speech and hearing disabled person. This communication involves online or offline communication

### SOLUTION TO PROBLEM

This invention creates a process compiled of video interpretation, natural language generation and natural language understanding for context based meaningful communication between speech and hearing disabled person with normal person. This is a real time process inexpensive simple to use and I and can be used for online communication. The developed process is low cost and user-friendly, easy to adopt.

### ADVANTAGEOUS EFFECTS OF INVENTION

This solution gives faster and accurate way of communication between normal person and speech and hearing disabled person. it will give equal opportunity 2 speech and hearing disabled person in every aspect of life. as we are using sign language interpretation (facial expressions/hand gestures) using video/image analysis to meaningful sentences/paragraph it allows meaningful longer communications between both the parties. as we are focusing on context based communication domain specific vocabulary and context will be understood and used.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a system architecture for Smart visual sign language translator, interpreter and generator. Wherein, Person with Speech and/or Hearing disability (PwD) (Speech and/or Hearing) (100) communicates messages through sign language using a device with video calling capability denoted by (101). A video Conferencing system (102) decodes meaning of sign language using Real-time video analytics. (103) is a module to segment video received from (101) into image frames. In module Image (Sign) to Text interpretation using DCN trained model (104), images/sequence of images (shots) are mapped with closest matching meaning of sign images or sequence of sign images for image to text interpretation. Text interpretation received from (104) is further processed for generating meaningful context-based text in module of Natural language Generation (NLG) for meaningful context-based interpretation (105). Output received from (104) is input for (105). Text generated in (105) is displayed on screen of output device (106). Text from (106) is read out loud using text to speech coveter module (107). Any normal person (108) can see text on (106), and listen to speech in (107). A person (108) is now in a position to understand what PwD (100) wants to communicate.

This flow explains one side communication. The invention supports two-way communication between PwD (100) and Normal person (108). When Normal Person (108) responds to (100), we have designed different block for making this communication happen. Video Conferencing system module (116) at normal person (108) side focuses on decoding meaning of sign language using Real-time video analytics. Communication from (108) is converted to text using speech to text converter (109) where speech recognition is done using DNN. Module of Text and context analysis using Natural Language Understanding (110) analyses text received from (109) using DNN (like BERT/LNet). Text and context understood from (110) is used for predicting text to nearest sign image. These sign images are used for creating meaningful sequence of sign language gestures in (112). (112) refers to (114) which is sign language video database with respective meaning with key terms, tokens. (114)) and (112) collectively provides input for Animation of sign gestures (113) which are predictions generated from server hosted DCN model and Text of the same. Animation of sign gestures is displayed on (101) which can be easily understood by (100). Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DESCRIPTION OF EMBODIMENTS

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

Person A (specially abled/Speech or Hearing disabled) communicates messages through sign language. Real-time videos will be captured every 30 seconds in live Video calls/meetings then 30 min frame will be sent to a cloud-hosted pre-trained Deep learning model as Input. Deep Learning model is trained on video-sentence pairs and learns to associate a sequence of video frames with a sequence of words to generate a description of the event in the video clip.

To handle the challenge of variable length output sequence of words for the video description a sequence-to-sequence model is used in the invention which is trained end-to-end and can learn arbitrary temporal structure in the input sequence. Our model is a sequence-to-sequence in the sense that it reads in frames. To improvise the accuracy of interpretation DCN model is used for training. The detailed steps for training Deep Convex model are as follows:
a. This model takes images/video frames as input data and predict sign language meaning in English (the invention is experimented with American English, the same logic is applicable to other languages) in the live call. For the model-building process, the annotated Images/Frames corresponding to American Sign Language and its interpretation available as open-source dataset named is used. The interpretation predicted from the previous step is used as input for context-based natural language generation. Natural Language generation deep learning model aims to teach itself to be able to read and interpret text and use this knowledge to write new text which is one of the inventive steps of the invention.
b. Text generated in the previous step is converted into speech, using gTTS (or equivalent text to speech translator). This speech audio is played live with animated personal videos.
c. In the second stage, it's about communication between a Natural person and a specially abled person. During live video call when a natural person speaks, his speech is captured and converted to text using any available speech to text convertor. This text is analyzed to get key terms, and phrases using text pre-processing. These key phrases/sentences/group of sentences will be matched with the nearest sentences/group of sentences using Sentence Semantics (to be specific Sentence Transformers) which are already stored in existing database using beam search. Once the nearest possible/matching sentence/group of sentences are mapped to image/Sequence of images with the meaning using DNN trained model, predicted images are used to create animation/AR to create videos with sign language depicting natural person.
d. For creating the DNN training model, open-source data sets are used which contains sign language videos and their meaning/captions. To build the training model, videos are broken down into images/sort frames (minimum 30 sec). Database with sign images/frames with their meaning are stored in the form of pair (image, meaning). For prediction purposes, first sentences directly received are looked for because of speech-to-text, as well as matching sentences/key phrases using sentence semantics to find the nearest possible sentence with a similar meaning are predicted. For sentence comparison, MOVERscore (or equivalent to find best matching word/phrase) technique is used. MOVERscore uses contextualized embeddings to compute the Euclidean distances between words or n-grams. For comparing performance of a model which maps sign image caption/description with sign image Consensus-based Image Description Evaluation (CIDEr) or equivalent is used.

Embodiments of the present invention will be described below in detail with reference to the accompanying drawings.

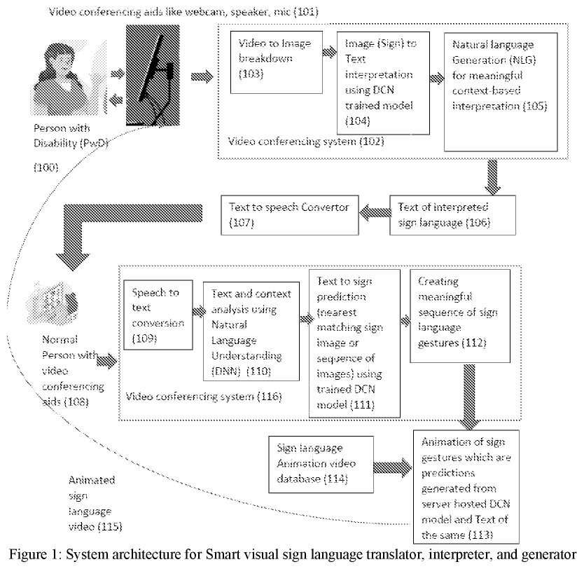

FIG. 1 illustrates system architecture for Smart visual sign language translator, interpreter and generator. Person with disabilities PwD (Speech and/or Hearing) (100) communicates messages through sign language using a device with video calling capability denoted by (101). Our invention is focused on understanding the meaning of signs using AI/ML models to convert sign language to text, so that anyone can read the interpretation. Video Conferencing system (102) decodes meaning of sign language using Real-time video analytics. (102) has module (103) to segment video received from (101) into image frames. In module Image (Sign) to Text interpretation using DCN trained model (104), images/sequence of images (shots) are mapped with closest matching meaning of sign images or sequence of sign images for image to text interpretation. Separate Deep learning network (DCN) is used for (104). Text interpretation received from (104) is further processed for generating meaningful context-based text in module of Natural language Generation (NLG) for meaningful context-based interpretation (105) using Turing, MT-NLG and Transformer-based like generative language model. Output received from (104) is input for (105). Text generated in (105) is displayed on screen of output device (106). Text from (106) is read out loud using text to speech coveter module (107). Any normal person (108) can see text on (106), and listen to speech in (107). A person (108) is now in a position to understand what PwD (100) wants to communicate.

The invention supports two-way communication between PwD (100) and normal person (108). When Normal Person (108) responds to (100), we have designed different block for making this communication happen. Video Conferencing system module (116) at normal person (108) side focuses on decoding meaning of sign language using Real-time video analytics. Communication from (108) is converted to text using speech to text converter (109) where speech recognition is done using DNN. Module of Text and context analysis using Natural Language Understanding (110) analyses text received from (109) using DNN (like BERT/LNet). Text and context understood from (110) is used for predicting text to nearest sign image. These sign images are used for creating meaningful sequence of sign language gestures in (112). (112) refers to (114) which is sign language video database with respective meaning with key terms, tokens. (114)) and (112) collectively provides input for Animation of sign gestures (113) which are predictions generated from server hosted DCN model and Text of the same. Animation of sign gestures is displayed on (101) which can be easily understood by PwD (100). Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

### EXAMPLES

### Example 1

Person with speech and hearing (PwD) disability working in IT industry and interacting with normal person.

### Example 2

Live Online training tool where PwD can act as tutor or student.

### INDUSTRIAL APPLICABILITY

This process provides way of real time communication between hearing and speech disabled person with a normal person with more accuracy and speed. This invention will be useful across all the industries where human to human connection is required and one of the person is partially or fully speech and hearing disable.

Hearing and speech disabled people are not part of the mainstream in corporate or other professional sectors. Our invention uses an Artificial intelligence-based model for real time communication between PwD with normal people.

All the industries who want to implement diversity and believe in giving equal opportunity to everyone can use this invention for inclusion of PwD in mainstream.

All online meeting platforms like zoom/Google meet/Webex can you use this process for creating real time communication channel between persons with disability and normal person with better accuracy and meaningful context.

All universities, educational institutes can you use this invention for providing education to PwD. Currently persons with disability have different educational institutes add they can't get education/learning with normal students. By using this invention persons with disability can enroll for any professional degrees/courses.

All retail outlets/shopping malls can hire persons with disability and use this process for creating communication channel with customers.

All learning management systems (LMS) can you use this process for interpreting normal live/records video lectures to sign language enabling persons with disability way of self-paced learning, self-development resulting in better opportunities.

### CITATION LIST

Citation List follows:

### Patent Literature

PTL 1 discloses the invention of dynamic and adaptive eLearning system for improvement of the productivity of learners and smart attendance monitoring through appropriate interaction and feedback. Particularly this invention is for taking attendance using face recognition and attentiveness detection. It is sent as feedback but not used anywhere in order to modify the online lecture. Whereas, in our invention this feedback is used for modifying video sequence of pre-recorded lectures.

PTL 2 discloses the real-time portable tele-education method based on cognitive load and learning style from BCI data using CI based techniques and content services. It uses BCI, EEG and brain wave detection to calculate cognitive load of learners and adapts courseware that includes lessons, tasks etc. in runtime. However, it does not focus on dynamic sequencing of learning video lectures. Also, camera feed is not used here for attentiveness detection.

PTL 3 discloses system and method for automated course individualization via learning behaviours and natural language processing. In this invention, content is tagged using NLP and then the most relevant content path for the user from the available content is found. This path is changed at regular intervals like module completion. Moreover, facial expressions, cues or attentive level is not used to detect the learner's response for adaptive real time video content delivery.

PTL 4 discloses invention about personalized and adaptive math learning system. The scope of the invention limits to teaching only maths subject. The invention does not make use of camera feed from students. However, the system makes use of background information of students to create learner's profile. Lesson plans are adapted accordingly. Changing the sequence of video or live lectures are not mentioned anywhere in the said invention.

PTL 1: Patent IN202031055451

PTL 2: Patent IN202031055111

PTL 3: Patent US20160314699

PTL 4: Patent US20200258420

### Non-Patent Literature

None

In the prior work, there are many systems proposed for sign language translator and interpreter, but smart automated process of visual sign language translator and interpreter using deep convex network which gives higher accuracy and video of sign language generator in real time for normal person's speech in real time by understanding the context using NLP techniques is not disclosed anywhere. Our invention, proposes a methodology with which in this digital era PwD will also become part of the mainstream in corporate or other professional sectors and contribute hand in hand as normal person can do.

We claim:

1. A Smart visual sign language translator, interpreter and generator, the said system comprising:
a. video conferencing aids (101 and 108) like a webcam for capturing hand gestures of the person with hearing and/or speech disabilities (PwD), speakers to read aloud interpreted sign meaning, a mic for normal person to communicate;
b. a video conferencing system (102) at PwD (100) side comprising:
video to image breakdown module (103) to convert PwD sign gestures captured in real time as video into sequence of images, image (Sign) to text interpretation using Deep Convex network (DCN/DSN) also known as deep stack network trained model (104) for sign language interpretation, Natural language Generation (NLG) using generative language model like Turing, MT-NLG and transformer-based for meaningful context-based interpretation (105);
c. a video conferencing system (116) at a natural person (108) side comprising:
speech to text conversion (109), text and context analysis using natural language understanding using DNN (110), text to sign prediction using trained DCN model (111), creating meaningful sequence of sign language gestures (112) using sign language animation video database (114), wherein; (116) makes use of trained models using Deep Convex network (DCN/DSN) for natural language understanding, does mapping text to sign language (111) and displaying text as well as animation of sign gestures (113) simultaneously;
d. a module to display text (106) of interpreted sign language by the video conferencing system (102);
e. a text to speech Convertor (107) to read aloud the text displayed by (106);
f. an animation of sign gestures and text (113) which are predictions generated from server hosted DCN model (116);
g. an animated sign language video (115) using (113) is played at PwD side (101)

2. The system claimed in claim 1 is a process of two-way real time communication between PwD and normal person, wherein sign language of PwD (100) is captured, processed, interpreted using DCN trained model (104) and context based Natural language generation (105); and then converted into text (106) and speech (107) for a normal person to understand; similarly, communication of normal person is captured, processed (110), interpreted using trained DCN (111) and mapped with appropriate sign language video (112), (113) which is played at PwD side (101) in real time.

3. The system claimed in claim 1 is a process of smart visual sign language translator, interpreter and generator, wherein the said process comprising:
i. Person with disabilities PwD (Speech and/or Hearing) (100) communicates messages through sign language using a device with video calling capability denoted by (101);
ii. the video conferencing system at PwD side (102) decodes meaning of sign language using real-time video analytics; wherein video conferencing system (102) comprising video to image breakdown module (103), to segment video received from webcam (101) into image frames; an image (Sign) to text interpretation is carried out in module (104) using DCN trained model; wherein sequence of images (shots) is mapped with closest matching meaning of sign images or sequence of sign images for image to text interpretation; separate deep learning network (DCN) is used for sign to text interpretation (104);
iii. the text interpretation received from (104) is processed for generating meaningful context-based text using NLG models like Turing, MT-NLG in (105); output received from (104) is input for (105);
iv. the text generated in (105) is displayed on screen of output device (106); wherein text from (106) is read out aloud using text to speech converter module (107); any normal person (108) can see text on (106), and listen to speech in (107);
v. the normal person (108) is now in a position to understand what PwD (100) wants to communicate;
vi. when the normal Person (108) responds or communicates to PwD (100), the video conferencing system module (116) at normal person (108) side decodes meaning of sign language using real-time video analytics; wherein communication from (108) is converted to text using speech to text converter (109) where speech recognition is done using DNN trained model; module of text and context analysis using Natural Language Understanding (110) analyses text received from (109) using DNN (like BERT/XLNet); text and context understood from (110) is used for predicting text to nearest sign image; these sign images are used for creating meaningful sequence of sign language gestures in (112); (112) refers to (114) which is sign language video database with respective meaning with key terms, tokens; (114)) and (112) collectively provides input for animation of sign gestures (113) which are predictions generated from server hosted DCN model and also displays text of the interpreted communication;
vii. the animation of sign gestures is displayed on (101) which can be easily understood by PwD (100).
